(19) United States
(12) Patent Application Publication
(10) Pub. No.: US 2015/0372575 A1
(43) Pub. Date: Dec. 24, 2015

(54) HIGH SPEED INDUCTION MACHINE WITH FRACTIONAL-SLOT TOOTH-COIL WINDING

(71) Applicant: GARDNER DENVER, INC., Milwaukee, WI (US)

(72) Inventor: Radu Stefan CURIAC, Atlanta, GA (US)

(21) Appl. No.: 14/308,426

(22) Filed: Jun. 18, 2014

(51) Int. Cl. H02K 17/16; H02K 3/12

(52) U.S. Cl. CPC H02K 17/165; H02K 3/12

(57) ABSTRACT

A high speed induction motor assembly comprising a solid, multilayer rotor and a stator core with a fractional-slot tooth-coil winding is provided. The ratio of slots number per pole and phase is sub-unitary. The rotor includes a solid ferromagnetic core coated with a layer of copper. Due to the permeability of the copper material coating the solid rotor core, the motor assembly may have an effective radial magnetic air-gap that is larger than its mechanical radial air gap, which is defined between the inner surface of the stator core and the outer surface of the copper layer coating the solid rotor core.

### CROSS-REFERENCE TO RELATED APPLICATIONS

None.

### BACKGROUND OF THE INVENTION

Poly-phase induction motors comprising a stationary stator assembly and a rotating rotor assembly are well known and widely used in industrial applications. The stator assembly of such an induction motor includes normally a stator core and a stator winding, both of them housed in the stator frame. The stator core contains typically a plurality of ferro-magnetic thin annular laminations with a circular inner hole, stacked together and pressed in a cylindrical arrangement. Each stator annular lamination has punched slots in the proximity of the circular inner hole. The stator slots are partly open. Often, a stator double layer winding with three phases shifted at 2π/3, formed by distributed coils, is housed in the stator slots. The stator winding, energized from a three phase power supply, generates a rotating magnetic field which induces a current in a rotor winding by induction; a torque is produced by the current and the magnetic flux of the rotating magnetic field, and the rotor rotates in the same direction as that of the rotating magnetic field. In case of variable speed drives, the machines have been energized by PWM frequency converters. The rotor can be composed of a core made of laminated iron sheets and a winding. In cage-type motors, an aluminum or copper winding is molded in the rotor core slots and the winding is made of bars. Alternatively the rotor-cage can be fabricated. In both cases the bars forming the winding are connected together by two end rings, an end ring is at each end of the rotor core. The described rotor structure severely limits the peripheral speed by causing of local stress concentrations. Since the stresses are concentrated in the core part of the rotor, composed of laminated steel sheets, due to the centrifugal forces caused by the high rotational speed, the peripheral speed must be limited to about 240 m/s to prevent the rotor core from being fractured. Therefore, this rotor type is not suitable for variable, high speed drive applications.

U.S. Pat. No. 5,473,211 provides an integrated structure of the rotor by coating the entire surface of a solid steel core with a high electrical conductivity material (e.g. copper), so that high rotational speeds are possible by using a larger air-gap than the conventional value.

It is common for induction motors to have a three phase symmetrical system of voltages at their terminals, the currents running through the phases having their own set of winding coils wound around the stator core through the stator slots.

### SUMMARY OF THE INVENTION

One embodiment of the present invention involves the provision of a high speed electric induction motor assembly that comprises a stator core with a fractional-slot tooth-coil winding. A rotor of the motor includes a solid core overlapped at least in part, by a layer of copper. The term copper as used herein does not mean pure copper unless stated. It is broad enough to encompass copper alloy. The rotor may be fabricated by clad concentric cylinders. The stator core has a plurality of circumferentially-spaced, axially-extending slots defined therein. The stator core further includes an inner surface defining an internal cavity that receives at least a portion of the rotor therein. A mechanical radial air gap is defined between the inner surface of the stator core and the outer surface of the rotor. Due to the magnetic permeability of the layer of copper on the rotor core, the motor assembly may have an effective magnetic radial air-gap that is larger than the mechanical radial air gap. The winding of the stator core includes a plurality of circuits each carrying current at a different phase. In one embodiment, portions of at least two circuits carrying current at different phases are disposed within each slot.

One embodiment of the motor assembly has 18 slots, 12 poles, and a two-layer winding that includes three circuits, each carrying a current of a different phase. There are three phases. Another embodiment has 6 slots, 4 poles, and also a two-layer winding that includes three circuits each carrying a current of a different phase. There are also three phases. As such, the ratio of the number of slots per pole per phase is sub-unitary. Each slot contains at least portions of two circuits. Each portion of each circuit in the slot carries a current of a different phase. Each portion of a circuit housed in a slot is formed from a different tooth coil. The portion of a tooth coil in a slot is the tooth coil side.

The three circuits making up the winding each have a different circuit pattern relative to the stator core slots. Each circuit pattern carries a current at a different phase. The first circuit forming the first pattern carries the current of the first phase. Starting from the first slot of the stator, the first circuit is configured in a manner wherein the circuit can be described in the clockwise direction as extending from the stator core first axial end axially in a first direction through the first slot of the stator core to the stator core second axial end, axially in a second direction from the stator core second axial end through a second slot, axially in the first direction from the first axial end through a fourth slot, and axially from the second axial end in the second direction through a fifth slot. The first direction is opposite the second direction. This pattern of the circuit, carrying current of a first phase, can be continued, if necessary, based on the number of slots, around the stator internal circumference. The portion of the first circuit in each slot is formed from tooth coils of the first circuit. More particularly a tooth coil forms the portion of the circuit in the first and second slots. Another tooth coil forms the portion of the first circuit in the fourth and fifth slots. A tooth is between each pair of adjacent slots in which the first circuit lays. A different tooth coil of the first circuit wraps around each tooth between adjacent slots in which the first circuit lays. A different single tooth coil forms the portions of the first circuit in each pair adjacent slots in which the first circuit lays. The tooth coils are connected in series. The current of the first phase travels the same pathway as the first circuit described above.

The second circuit forms a second pattern different from the first pattern relative to the stator core slots. The second circuit carries the current of the second phase. Starting from the first axial end and going in the clockwise direction, the second circuit is configured in a manner wherein the circuit can be described as extending from the stator core first end axially in the first direction through the second slot of the stator core to the stator core second axial end, axially in the second direction from the stator core second axial end through the third slot, axially in the first direction from the first axial end through the fifth slot, and axially in the second direction from the second axial end through the sixth slot. This pattern of the circuit, carrying the second phase, can be continued, if necessary, based on the number of slots, around the stator internal circumference. The portion of the second circuit in each slot is formed from tooth coils of the second circuit. More particularly a tooth coil forms the portion of the second circuit in the second and third slots. Another tooth coil forms the portion of the second circuit in the fifth and sixth slots. A tooth is between each pair of the adjacent slots in which the second circuit lays. A different tooth coil of the second circuit wraps around each tooth between adjacent slots in which the first circuit lays. A different single tooth coil forms the portions of the second circuit in each pair adjacent slots in which the second circuit lays. The tooth coils are connected in series. The current of the second phase travels the same pathway as the second circuit as described above.

The third circuit has a third pattern different from the first and second patterns relative to the slots in the stator core. The third circuit carries the current of a third phase. Starting from the first axial end and going in the clockwise direction, the third circuit is configured in a manner wherein the circuit can be described as extending from the stator core first end axially in the first direction through the third slot of the stator core to the stator core second axial end, axially in the second direction through the fourth slot from the stator core second axial end, axially in the first direction through the sixth slot form the stator core first axial end, and axially in the second direction through the seventh slot form the stator core second axial end. Again this pattern of the circuit carrying the current of the third phase can be continued, if, necessary, based on the number of slots, around the stator internal circumference. The portion of the third circuit in each slot is formed from tooth coils of the third circuit. More particularly a tooth coil forms the portion of the third circuit in the third and fourth slots. Another tooth coil forms the portion of the third circuit in the sixth and seventh slots. A tooth is between each pair of the adjacent slots in which the third circuit lays. A different tooth coil of the third circuit wraps around each tooth between adjacent slots in which the first circuit lays. A different single tooth coil forms the portions of the third circuit in each pair of adjacent slots in which the third circuit lays. The tooth coils are connected in series. The current of the third phase travels the same pathway as the third coil as described above.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1a is an exploded side perspective view of an electric induction motor showing an 18-slot stator core and a copper clad solid rotor in accordance with a first embodiment of the present invention;

FIG. 1b is a perspective view of one of the tooth coils of the plurality of tooth coils that make up the winding of the stator core;

FIG. 2 is a schematic cross-sectional view of the induction motor of FIG. 1 with the 18-slot core; FIG. 2 includes the winding omitted from FIG. 1;

FIG. 3 is a schematic opened diagram illustrating the winding pattern of the motor of FIG. 1 having a 12-pole, 18-slot core and winding in accordance with the first embodiment of the present invention;

FIG. 4 is a schematic cross-sectional view of an induction motor having a stator with 6-slot core and winding in accordance with a second embodiment of the present invention; and

FIG. 5 is a schematic opened diagram illustrating the winding pattern of the induction motor of FIG. 4 having a 4-pole, 6-slot core and winding in accordance with the second embodiment of the present invention.

### DETAILED DESCRIPTION OF THE INVENTION

A need exists for a high speed induction motor that has shorter, non-overlapping ends of the winding in order to decrease the stator winding losses, increase efficiency and reduce the overall motor size. A further need exists for a stator winding for an induction motor that can be manufactured using less winding material, using simpler procedures and at a reduced cost.

An embodiment of the invention is disclosed with reference to the drawing figures, in which like reference numerals refer to like parts throughout. For purposes of clarity in illustrating the characteristics of the present invention, proportional relationships of the elements have not necessarily been maintained in the drawing figures.

The following detailed description references specific embodiments. The embodiments are intended to describe aspects of the invention in sufficient detail to enable those skilled in the art to practice the invention. Other embodiments can be utilized and changes can be made without departing from the scope of the present invention. The present invention is defined by the appended claims and the description and is, therefore, not to be taken in a limiting sense and shall not limit the scope of equivalents to which such claims are entitled.

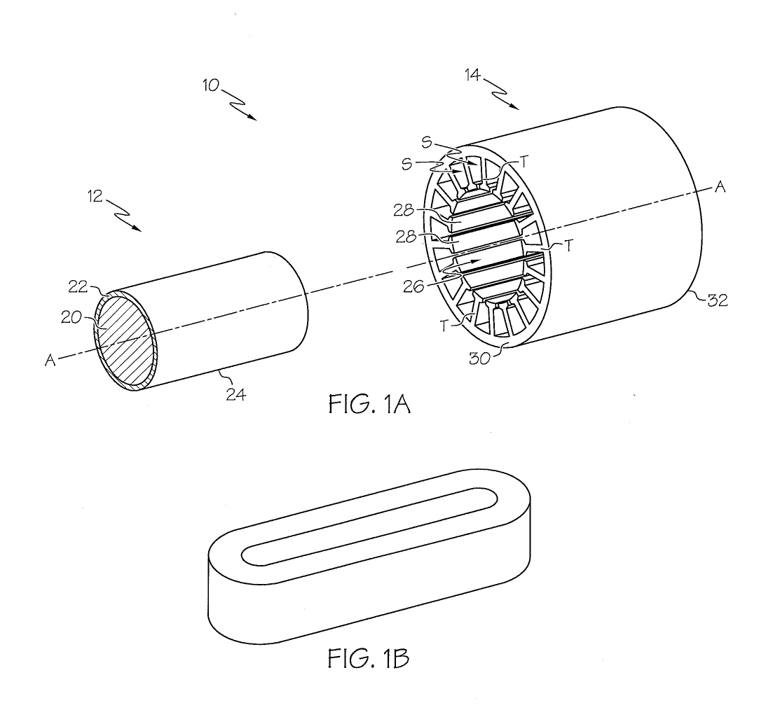

The present invention is directed generally to a high speed induction motor 10 having a fractional-slot tooth-coil winding. The motor 10 generally comprises, a stator core 14, a rotor 12 and a uniquely wound winding 16. FIG. 1 is an exploded view of the motor 10 showing the rotor 12 and stator core 14. It should be noted that, in order to best illustrate, the motor topology, the winding 16 is not shown in FIG. 1. Although a motor is shown, the invention is applicable to other types of machines such as a generator.

The rotor 12 mainly includes the solid core 20 with, at least in part, forming its outer surface, a layer 22 of conductive material. The solid core is ferromagnetic and can be steel and the copper layer can be clad on the core. The core is cylindrical and circular. In one embodiment, the solid core 20 can also be continuous with a shaft for a high speed blower. The rotor and shaft can be configured as shown in U.S. Pat. No. 5,473,211 which is incorporated by reference herein in its entirety. The conductive layer includes copper, or other suitable highly conductive material. The rotor core 20 is a radial inward layer and the conductive layer 22 is a radial outward layer. Layer 22 is highly conductive. While not shown, it will be understood that a component, such as a gear or an impeller for a pump or compressor, may be attached to one or both ends (not shown) of the shaft formed with rotor 12. The copper layer 22, which may be between about 2.0 mm-2.5 mm in thickness in one embodiment, has an outer cylindrical and circular surface 24 with a substantially circular cross section suitable for placement within a cavity 26 defined in the stator core 14. When the rotor 12 is positioned within the stator core 14, a portion of the rotor 12 which is continuous with the core may protrude beyond one or both axial ends 30, 32 of the stator core 14. The portion formed with the core 20 that extends beyond the axial ends 30, 32 of the stator core 14 can be rotatably coupled to a housing (not shown) that surrounds the motor 10 and rotatably supports the rotor 12 when the rotor 12 is positioned within the stator core 14. In the present example the structure forming the coupling which couples the rotor 12 to the housing would comprise a magnetic bearing system.

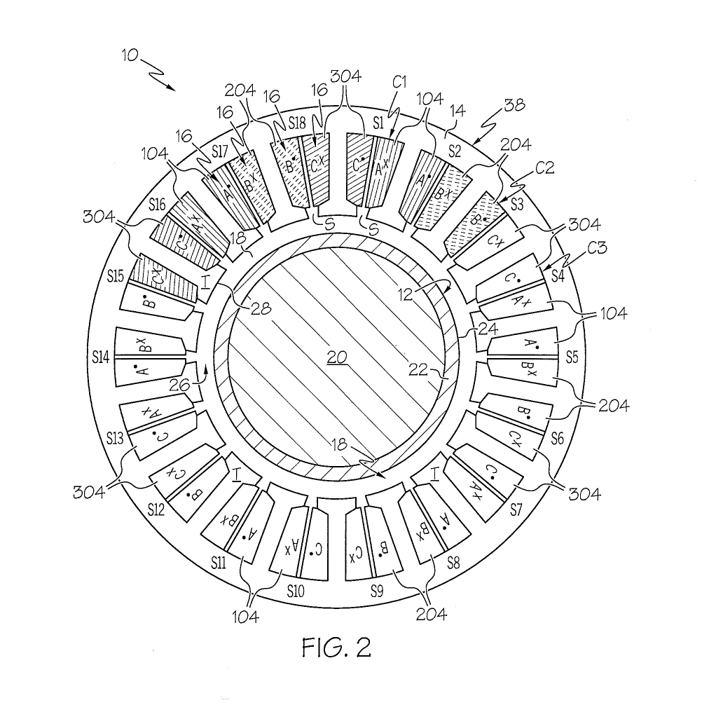

The stator core 14's internal cavity 26, which can also be called a hollow, has a substantially circular cross section defined by an inner peripheral surface 28. The internal cavity 26 is configured to receive the rotor 12 and the rotor 12 is configured to rotate within the internal cavity 26. As depicted in FIG. 2, the outer surface 24 of the rotor's copper layer 22 and the inner peripheral surface 28 of the stator core 14 are separated by a mechanical radial air gap 18 that is defined therebetween, through which, due to induction, energy is transferred from the stator assembly 38 to the rotor 12. In one embodiment, the mechanical air gap 18 may be 2.0 mm-2.5 mm wide. By using a copper layer 22 having a 2.0 mm-2.5 mm thickness, which has the same relative permeability with that of the air, the stator 14 can have a larger magnetic air gap than if no copper layer were added. The mechanical air gap is the radial distance between an outer surface of the rotor 12, which in this case is the outer surface 24 of the copper layer 22, and the internal surface 28 of the stator 14. The mechanical air gap shown is 2.5 mm. The magnetic air gap is the mechanical air gap plus the thickness of the copper layer. The copper layer shown has a thickness of 2.5 mm. Thus, the magnetic air gap is 5 mm. The larger, magnetic effective air gap exists because of the same permeability of the outer rotor copper layer 22 and the air which forms the air-gap 18. This larger effective gap results in the ability for a fractional-slot tooth-coil winding to be used in the high speed induction motor 10 without the drawbacks of electrical performance that would otherwise occur in a standard induction motor due as a result of the harmonic magnetomotive force (mmf) components. It may be possible that the air gap may be as much as 5.0 mm wide and the copper layer may be as much as 4.0 mm in thickness.

The stator core 14 includes a plurality of slots S opening through the inner peripheral surface 28 that extend from the first axial end 30 to the second axial end 32 of the stator core 14 and are parallel to the central axis A-A of the motor 10. In the embodiment illustrated in FIGS. 1-3, the stator core 14 includes eighteen slots S. As shown in FIG. 2, each of the slots S is individually numbered, beginning with slot S1 and proceeding clockwise to slot S18. Each slot is bound on each side in the circumferential direction by a tooth T. There are 18 teeth T. Accordingly a slot S is between each pair of adjacent teeth T. Also each pair of adjacent slots is separated by a tooth T. Although the stator core 14 of FIGS. 1-3 includes eighteen slots S, it is understood that other quantities of slots S may be used in other embodiments of the present invention. Further, it is understood that the geometry, including the cross sectional shape and size, of the slots S may vary.

The winding 16 comprises a plurality of circuits C1, C2, C3, which may be realized of insulated litz wires or other constructions. Litz type conductors are useful in order to decrease the effect of eddy currents generated due to high frequency operation. In the present example, there are three circuits C1, C2, C3; each carrying current having a different phase. Each circuit has a different winding pattern relative to the stator core. Each circuit in the present example includes a plurality of tooth coils connected in series. Circuit C1 includes a plurality of tooth coils 104; circuit C2 includes a plurality of tooth coils 204; and circuit C3 includes a plurality of tooth coils 304. As depicted, each slot S houses portions of two tooth-coils. Each of the tooth coil portions is a side of one of the two tooth coils housed in the slot. Each of the two tooth coil portions (sides) housed in a slot carries current at a different phase. Each portion (side) of a tooth coil in a slot extends along an entire axial length the respective slot S in which it is housed. Each tooth coil forming a portion of a circuit protrudes beyond both ends 30, 32 of the stator core 14. Each slot S is formed by a pair of adjacent teeth. Each pair of adjacent slots is separated by a tooth. Each tooth coil wraps around a tooth and lies in a pair of adjacent slots. In particular the opposite sides of each tooth coil lie in the pair of adjacent slots. Each tooth coil has a construction like the tooth coil shown in FIG. 1b.

FIG. 2a is a schematic view of the motor 10 of FIG. 1 showing the distribution of the phases of current carried by winding 16. The winding 16 carries currents running at three different phases. Each of the three phases is shifted by 2π/3. Each phase is represented by an “A,” “B” or “C”. A separate circuit C1, C2, C3, is used for each phase. Each of the circuits includes tooth coils in the slots S. The figure shows the distribution of tooth coils 104, 204 and 304 making up circuits C1, C2, C3 carrying the phased currents. An inward browse direction, first direction, of a circuit and a phase is designated by superscript “x” and the outward direction, second direction, is designated by superscript “” (e.g., A^{x}, A^{}, B^{x}, B^{}, C^{x} and C^{}).

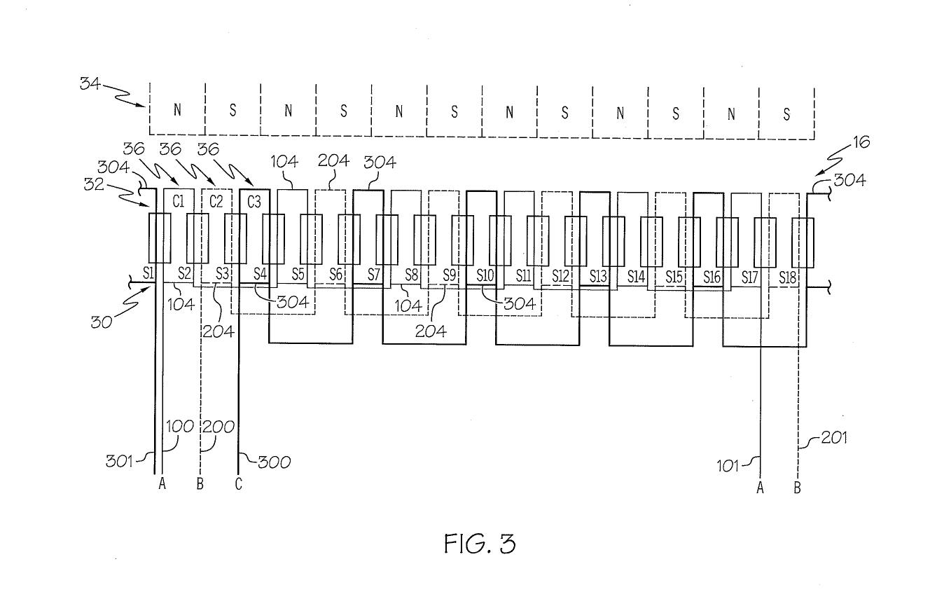

FIG. 3 schematically illustrates an opened representation of the winding configuration implemented in FIG. 2. As shown, the stator core 14 includes eighteen slots S and 18 teeth T. The illustrated winding configuration results in twelve poles 34. There are six N poles and six S poles which equal six pairs of poles, p as represented in broken lines in FIG. 3. There are three phases m. Therefore, because the ratio of the number of slots S to the number of poles 34 to the number of phases A, B, C is a non-integer (i.e., 0.5 slots/pole/phase), the motor 10 has a sub-unitary fractional-slot winding, as represented by the following:

S=18 slots

p=6 pairs of poles

m=3 phases

q=S/2p/m=18/12/3=0.5 slots/pole/phase

Referring to FIGS. 2 and 3, it is shown that the circuit C1 carrying the current of phase

A is configured, starting from the first slot of the stator and going in the clockwise direction, in a manner wherein the circuit can be described as a circuit that extends from the stator core first axial end 30 axially inwardly in the first direction in and through the first slot S1 of the stator core to the second axial end 32 of the stator core, exits S1 and crosses a tooth T between S1 and S2, enters slot S2 at the second end 32, travels axially outwardly in the second direction in and through slot S2, and exits slot S2 at the first end 30. The portion of the first circuit C1 in slot S1 and S2 is formed from one of the tooth coils of the plurality of tooth coils 104 of the first circuit C1. The circuit then enters slot S4 (located three slots clockwise from S1) at the stator core first end 30, extends inwardly, in the first direction, in and through slot S4, exits S4 and crosses tooth T between S4 and slot S5, enters slot S5 at the second end 32 extends outwardly, in the second direction, in and through slot S5, and exits S5. The portion of the circuit C1 in slot S4 and S5 is formed from another tooth coil of the tooth coils 104 of the first circuit C1. The circuit then enters slot S7 (located three slots clockwise from S4) at the first end 30, extends inwardly in the first direction in and through slot S7, exits slot S7 at the second end 32, crosses tooth T between S7 and slot S8, enters slot S8 at the second end 32, extends outwardly, in the second direction, in and through slot S8, and exits slot S8 at the first end 30. The portion of the circuit C1 in slot S7 and slot S8 is formed from another tooth coil of the tooth coils 104 of the first circuit C1. The circuit then enters slot S10 (located three slots clockwise from S7) at the first end 30, extends inwardly in the first direction in and through slot S10, exits slot S10 at the second end 32, crosses tooth T between S10 and slot S11, enters slot S11 at the second end 32, extends outwardly, in the second direction, in and through slot S11, and exits slot S11 at the first end 30. The portion of the circuit C1 in slot S10 and slot S11 is formed from another tooth coil of the tooth coils 104 of the first circuit C1. The circuit then enters slot S13 (located three slots clockwise from slot S10) at the first end 30, extends inwardly in the first direction in and through slot S13, exits slot S13 at the second end 32, crosses tooth T between S13 and slot S14, enters slot S14 at the second end 32, extends outwardly, in the second direction, in and through slot S14, and exits slot S14 at the first end 30. The portion of the circuit C1 in slot S13 and slot S14 is formed from another tooth coil of the tooth coils 104 of the first circuit C1. The circuit then enters slot S16 (located three slots clockwise from slot S13) at the first end 30, extends inwardly in the first direction in and through slot S16, exits slot S16 at the second end 32, crosses tooth T between S16 and slot S17, enters slot S17 at the second end 32, extends outwardly, in the second direction, in and through slot S17, and exits slot S17 at the first end 30. The portion of the circuit C1 in slot S16 and slot S17 is formed from another tooth coil of the tooth coils 104 of the first circuit C1. Each tooth coil 104 has a first and a second side. The sides are opposite each other. The sides of the tooth coils 104 form the portion of the circuit C1 in the slots. For example the portion of the circuit C1 in slots S1 and S2 are formed from the sides of a tooth coil of the plurality of tooth coils 104. The ends 100 and 101 of the first circuit of the stator winding are connected to the terminals of phase A.

In other words, along the repeating winding pattern, current of phase A travels axially inwardly in the first direction through a first slot S, axially outwardly in the second direction through a second slot S2 that is located one place clockwise from the first slot S1, axially inwardly in the first direction through a fourth slot S4 that is located three places clockwise from the first slot S1, and axially outwardly in the axial direction through a fifth slot S5 that is located four places clockwise from the first slot S1. This pattern of the current of phase A is continued in a clockwise direction around the remainder of the stator core 14.

The current of phase A at the start travels through a tooth coil 104 in slots S1 and S2, then through another tooth coil 104 in slots S4 and S5, then in another tooth coil 104 in slots S7 and S8, then in another tooth coil 104 in slots S10 and S11. This pattern is continued in a clockwise direction around the remainder of the stator core 14. The tooth coils 104 of the first circuit C1 are joined in series.

The second circuit C2 carrying the current at phase B is wound in a similar fashion to the circuit carrying the current at phase A. The winding pattern of the second circuit C2 for phase B is displaced from the winding pattern of the first circuit C1 carrying the current of phase A by one slot in the clockwise direction. As such, starting from the second slot S2 of the stator and going in the clockwise direction, the circuit can be described as a circuit that extends from the stator core first axial end 30 inwardly in the first direction in and through the second slot S2 of the stator core to the second axial end 32 of the stator core, exits S2 and crosses a tooth T between S2 and S3, enters slot S3 at the second end 32, travels outwardly in the second direction in and through slot S3, and exits slot S3 at the first end 30. The portion of the circuit C2 in slot S2 and S3 is formed from a tooth coil of the tooth coils 204 of the second circuit C2. The circuit then enters slot S5 (located three slots clockwise from S2) at the stator core first end 30, extends inwardly, in the first direction, in and through slot S5, exits S5 and crosses tooth T between S5 and slot S6, enters slot S6 at the second end 32, extends outwardly, in the second direction, in and through slot S6, and exits S6. The portion of the second circuit C2 in slot S5 and S6 is formed from another tooth coil of the tooth coils 204 of the second circuit C2. The second circuit then enters slot S8 (located three slots clockwise from S5) at the first end 30, extends inwardly in the first direction in and through slot S8, exits slot S8 at the second end 32, crosses tooth T between S8 and slot S9, enters slot S9 at the second end 32, extends outwardly, in the second direction, in and through slot S8, and exits slot S8 at the first end 30. The portion of the second circuit C2 in slot S8 and slot S9 is formed from another tooth coil of the tooth coils 204 of the second circuit C2. The circuit then enters slot S11 (located three slots clockwise from S8) at the first end 30, extends inwardly in the first direction in and through slot S11, exits slot S11 at the second end 32, crosses tooth T between S11 and slot S12, enters slot S12 at the second end 32, extends outwardly, in the second direction, in and through slot S12, and exits slot S12 at the first end 30. The portion of the second circuit C2 in slot S11 and slot S12 is formed from another tooth coil of the tooth coils 204 of the second circuit C2. The circuit then enters slot S14 (located three slots clockwise from slot S11) at the first end 30, extends inwardly in the first direction in and through slot S14, exits slot S14 at the second end 32, crosses tooth T between S14 and slot S15, enters slot S15 at the second end 32, extends outwardly, in the second direction, in and through slot S15, and exits slot S15 at the first end 30. The portion of the second circuit C2 in slot S14 and slot S15 is formed from another tooth coil of the tooth coils 204 of the second circuit C2. The circuit then enters slot S17 (located three slots clockwise from slot S14) at the first end 30, extends inwardly in the first direction in and through slot S17, exits slot S17 at the second end 32, crosses tooth T between S17 and slot S18, enters slot S18 at the second end 32, extends outwardly, in the second direction, in and through slot S18, and exits slot S18 at the first end 30. The portion of the second circuit C2 in slot S17 and slot S18 is formed from another tooth coil of the tooth coils 204 of the second circuit C2. Each tooth coil 204 has a first and a second side. The sides are opposite each other. The sides of the tooth coils 204 form the portion of the circuit C2 in the slots. For example the portion of the circuit C2 in slots S2 and S3 are formed from the sides of a tooth coil of the plurality of tooth coils 204. The ends 200 and 201 of the second circuit are connected to the terminals of phase B.

In other words, along the repeating winding pattern, the current of phase B travels axially inwardly in the first direction through a second slot S2. The second slot S2 is located on slot clockwise of a first slot S1. The current of phase B then travels axially outwardly in the second direction through a third slot S3 that is located one place clockwise from the second slot S2, axially inwardly in the first direction through a fifth slot S5 that is located three places clockwise from the second slot S2, and axially outwardly in the axial direction through a sixth slot S6 that is located four places clockwise from the second slot S2. This pattern of the current of phase B is continued in a clockwise direction around the remainder of the stator core 14.

The current of phase B at the start travels through a tooth coil 204 in slots S2 and S3, then through another tooth coil 204 in slots S5 and S6, then in another tooth coil 204 in slots S8 and S9, then in another the tooth coil 204 in slots S11 and S12. This pattern is continued in a clockwise direction around the remainder of the stator core 14. The tooth coils 204 of the second circuit C2 are joined in series.

The third circuit C3 for the current of phase C is configured, starting from the third slot S3 of the stator and going in the clockwise direction, in a manner wherein the circuit can be described as a circuit that extends from the stator core first axial end 30 inwardly in the first direction in and through the third slot S3 of the stator core to the second axial end 32 of the stator core, exits S3 and crosses a tooth T between S3 and S4, enters slot S4 at the second end 32, travels outwardly in the second direction in and through slot S4, and exits slot S4 at the first end 30. The portion of the third circuit C3 in slot S3 and S4 is formed from a tooth coil of the tooth coils 304 of the third circuit C3. The third circuit then enters slot S6 (located three slots clockwise from S3) at the stator core first end 30, extends inwardly in the first direction, in and through slot S6, exits S6 and crosses tooth T between S6 and slot S7, enters slot S7 at the second end 32, extends outwardly in the second direction, in and through slot S7, and exits S7. The portion of the third circuit C3 in slot S6 and S7 is formed from another tooth coil of the tooth coils 304 of the third circuit C3. The circuit then enters slot S9 (located three slots clockwise from S6) at the first end 30, extends inwardly in the first direction, in and through slot S9, exits slot S9 at the second end 32, crosses tooth T between S9 and slot S10, enters slot S10 at the second end 32, extends outwardly in the second direction, in and through slot S10, and exits slot S10 at the first end 30. The portion of the circuit C3 in slot S9 and slot S10 is formed from another tooth coil of the tooth coils 304 of the third circuit C3. The circuit then enters slot S12 (located three slots clockwise from S9) at the first end 30, extends inwardly in the first direction in and through slot S12, exits slot S12 at the second end 32, crosses tooth T between S12 and slot S13, enters slot S13 at the second end 32, extends outwardly in the second direction, in and through slot S13, and exits slot S13 at the first end 30. The portion of the circuit C3 in slot S12 and slot S13 is formed from another tooth coil of the tooth coils 304of the third circuit C3. The circuit then enters slot S15 (located three slots clockwise from slot S12) at the first end 30, extends inwardly in the first direction in and through slot S15, exits slot S15 at the second end 32, crosses tooth T between S15 and slot S16, enters slot S16 at the second end 32, extends outwardly, in the second direction, in and through slot S16, and exits slot S16 at the first end 30. The portion of the circuit C3 in slot S15 and slot S16 is formed from another tooth coil of the tooth coils 304 of the third circuit C3. The circuit then enters slot S18 (located three slots clockwise from slot S15) at the first end 30, extends inwardly in the first direction in and through slot S18, exits slot S18 at the second end 32, crosses tooth T between S18 and slot S1, enters slot S1 at the second end 32, extends outwardly, in the second direction, in and through slot S1, and exits slot S1 at the first end 30. The portion of the circuit C3 in slot S17 and slot S1 is formed from another tooth coil of the tooth coils 304 of the third circuit C3. Each tooth coil 304 has a first and a second side. The sides are opposite each other. The sides of the tooth coils 304 form the portion of the circuit C3 in the slots. For example the portion of the circuit C3 in slots S3 and S4 are formed from the sides of a tooth coil of the plurality of tooth coils 304. The ends 300 and 301 of the third circuit of the stator winding are connected to the terminals of phase C.

In other words, along the repeating winding pattern, the current of phase C travels axially inwardly in the first direction through a third slot S3. The third slot is located two slots clockwise of the first slot S1. The current then travels axially outwardly in the second direction through a fourth slot S4 that is located one place clockwise from the third slot S3, axially inwardly in the first direction through a sixth slot S6 that is located three places clockwise from the third slot S3, and axially outwardly in the axial direction through a seventh slot S7 that is located four places clockwise from the third slot S3. This pattern of the current of phase C is continued in a clockwise direction around the remainder of the stator core 14.

The current of phase C at the start travels through a tooth coil 304 in slots S3 and S4, then through another tooth coil 304 in slots S6 and S7, then in another tooth coil 304 in slots S9 and S10, then in another tooth coil 304 in slots S12 and S13. This pattern is continued in a clockwise direction around the remainder of the stator core 14. The tooth coils 304 of the third circuit C3 are joined in series.

The pathway the current of phases A, B and C travels through the slots S can be summarized in the following chart:

| | Inward (X) | Outward (•) |
|---|---|---|
| Phase A | S1 | S2 |
| | S4 | S5 |
| | S7 | S8 |
| | S10 | S11 |
| | S13 | S14 |
| | S16 | S17 |
| Phase B | S2 | S3 |
| | S5 | S6 |
| | S8 | S9 |
| | S11 | S12 |
| | S14 | S15 |
| | S17 | S18 |
| Phase C | S3 | S4 |
| | S6 | S7 |
| | S9 | S10 |
| | S1 | S13 |
| | S15 | S16 |
| | S18 | S1 |

The rotor 12 of the present invention claims a larger mechanical air gap 18 (e.g., 2.0 mm-2.5 mm, with a remnant permeability of μᵣ=1. The copper layer 22 adds an additional thickness (e.g., 2.0 mm-2.5 mm), with the remnant permeability of μᵣ≈1, such that the stator assembly 38 can have and realize an even larger effective magnetic air gap. In the present example the air gap is 2.5 mm and the copper layer is 2.5 mm. Thus the effective magnetic air gap is 5 mm. Due to the relatively larger effective magnetic air gap (e.g., 4.0 mm-5 mm) of the present invention, circuits using tooth-coils can be employed. It may be possible that the air gap may be as much as 5.0 mm wide and the copper layer may be as much as 4.0 mm in thickness.

The winding configuration of the present invention which uses tooth coils leads to shorter length end windings 36 (i.e., non-overlapping end windings) in the axial direction, thereby decreasing the winding's 16 resistive and additional losses, increasing the efficiency of the motor 10 and reducing the overall size of the motor 10, as the motor 10 has a shorter length. The non-overlapping windings are those end windings in adjacent slots which do not overlap. The shorter, non-overlapping end windings 36 also reduce the amount of material (copper wire) required to manufacture the windings 16, result in a higher power density due to the reduction of the motor's 10 volume, result in a winding 16 that is simpler to manufacture, thereby reducing labor requirements, and resulting in a motor 10 having better fault tolerance and a motor 10 having an overall reduced cost.

One of the important characteristics of the stator assembly 38 of the present invention is that its winding configuration has a number of slots (S), number of poles (2p) and number of phases (m), such that the number of slots per pole per phase (q) is less than 1.0, as represented by the following:
S==18 slots
p=6 pairs
m=3 phases
q=S/2p/m=18/12/3=0.5 slots/pole/phase

When the motor 10 illustrated in FIGS. 1-3 is supplied from a frequency converter at 2,400 Hz, the synchronous speed (nₛ) of the motor 10 is 24,000 revolutions per minute (rpm), as represented by the following:
f=2,400 Hz
2p=2×6=12 poles
nₛ=120*f/2p=120*2,400/12=24,000 rpm

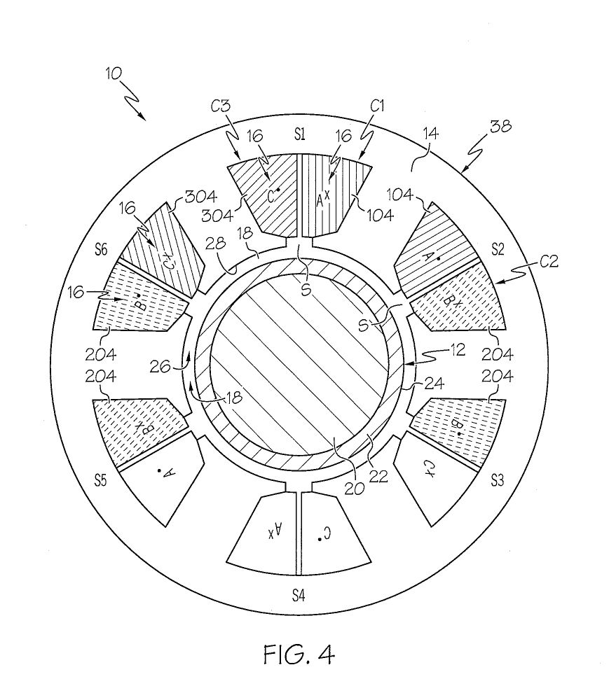

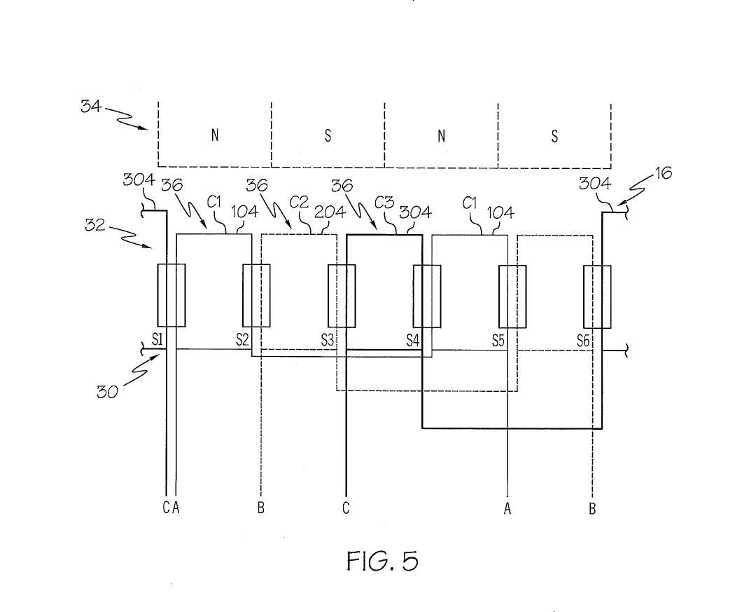

Turning now to FIGS. 4 and 5, a second embodiment of the present invention is illustrated that is constructed using concepts similar to those used in connection with the first embodiment shown in FIGS. 1-3 and described above. However, the embodiment of the motor 10 shown in FIGS. 4 and 5 includes six slots S and four poles (2 N poles, 2 S poles). As such, because the ratio of the number of slots S to the number of poles to the number of phases m is sub-unitary (i.e., 0.5 slots/pole/phase), the motor 10 is a sub-unitary fractional-slot winding motor, as represented by the following:
S=6 slots
2p=4 poles
m=3 phases
q=S/2p/3=0.5 slots/pole/phase

FIG. 4 is a schematic sectional view showing the motor 10 of the second embodiment and FIG. 5 is an opened representation of the winding configuration implemented in FIG. 4. It is shown that the winding 16 formed of circuits C1, C2, C3 carrying current respectively of phases A, B and C are all wound in with a different pattern relative to the stator core. The winding pattern of the circuit carrying current of phase B is offset from the winding pattern of the circuit carrying the current of phase A by one slot in the clockwise direction and the winding pattern of the circuit carrying the current of phase C is offset from the winding pattern of the winding of phase B by one slot in the clockwise direction.

Referring to FIGS. 4 and 5, it is shown that the circuit C1 carrying the current of phase A is configured, starting from the first slot S1 of the stator and going in a clockwise direction, in a manner wherein the circuit can be described as a circuit that extends from the stator core first axial end 30 inwardly in the first direction in and through the first slot S1 of the stator core to the second axial end 32 of the stator core, exits S1 and crosses a tooth T between S1 and S2, enters slot S2 at the second end 32, travels outwardly in the second direction in and through slot S2, and exits slot S2 at the first end 30. The portion of the first circuit C1 in slot S1 and S2 is formed from a tooth coil of the tooth coils 104 of the first circuit C1. The circuit then enters slot S4 (located three slots clockwise from S1) at the stator core first end 30, extends inwardly in the first direction, in and through slot S4, exits S4 and crosses tooth T between S4 and slot S5, enters slot S5 at the second end 32, extends outwardly, in the second direction, in and through slot S5, and exits S5. The portion of the circuit C1 in slot S4 and S5 is formed from another tooth coil of the tooth coils 104 o of the first circuit C1. Each tooth coil 104 has a first and a second side. The sides are opposite each other. The sides of the tooth coils 104 form the portion of the circuit C1 in the slots. For example the portion of the circuit C1 in slots S1 and S2 are formed from the sides of a tooth coil of the plurality of tooth coils 104. The ends 100 and 101 of the first circuit of the stator winding are connected to the terminals for the current of phase A.

In other words, along the repeating winding pattern, the current of phase A travels axially inwardly in the first direction through a first slot S1, axially outwardly in the second direction through a second slot S2 that is located one place clockwise from the first slot S1, axially inwardly in the first direction through a fourth slot S4 that is located three places clockwise from the first slot S1, and axially outwardly in the axial direction through a fifth slot S5 that is located four places clockwise from the first slot S1.

The current of phase A at the start travels through a tooth coil 104 in slots S1 and S2, then through another tooth coil 104 in slots S4 and S5. The tooth coils 104 of the first circuit C1 are joined in series.

The second circuit C2 carrying the current of phase B is configured, starting from the second slot S2 of the stator and going in the clockwise direction, in a manner wherein the circuit can be described as a circuit that extends from the stator core first axial end 30 inwardly in the first direction in and through the second slot S2 of the stator core to the second axial end 32 of the stator core, exits S2 and crosses a tooth T between S2 and slot S3, enters slot S3 at the second end 32, travels outwardly in the second direction in and through slot S3, and exits slot S3 at the first end 30. The portion of the second circuit C2 in slot S2 and S3 is formed from a tooth coil of the tooth coils 204 of the second circuit C2. The circuit then enters slot S5 (located three slots clockwise from S2) at the stator core first end 30, extends inwardly in the first direction, in and through slot S5, exits S5 and crosses tooth T between S5 and slot S6, enters slot S6 at the second end 32, extends outwardly, in the second direction, in and through slot S6, and exits S6. The portion of the circuit C2 in slot S5 and S6 is formed from another tooth coil of the tooth coils 204 of the second circuit C2. Each tooth coil 204 has a first and a second side. The sides are opposite each other. The sides of the tooth coils 204 form the portion of the circuit C2 in the slots. For example the portion of the circuit C2 in slots S2 and S3 are formed from the sides of a tooth coil of the plurality of tooth coils 204. The ends 200 and 201 of the second circuit of the stator winding are connected to the terminals for the current of phase B.

In other words, along the repeating winding pattern, the current of phase B travels axially inwardly in the first direction through a second slot S2. The second slot S2 is located one space clockwise of the first slot S1. The phase B current then travels axially outwardly in the second direction through a third slot S3 that is located one place clockwise from the second slot S2, axially inwardly in the first direction through a fifth slot S5 that is located three places clockwise from the first slot S2, and axially outwardly in the axial direction through a sixth slot S6 that is located four places clockwise from the second slot S2.

The current of phase B at the start travels through a tooth coil 204 in slots S2 and S3, then through another tooth coil 204 in slots S5 and S6. The tooth coils 204 of the second circuit C2 are joined in series.

The third circuit carrying the current of phase C is configured, starting from the third slot S3 of the stator and going in a clockwise direction, in a manner wherein the circuit can be described as a circuit extending from the stator core first axial end 30 inwardly in the first direction in and through the third slot S3 of the stator core to the second axial end 32 of the stator core, exits S3 and crosses a tooth T between S3 and slot S4, enters slot S4 at the second end 32, travels outwardly in the second direction in and through slot S4, and exits slot S4 at the first end 30. The portion of the third circuit C3 in slot S3 and S4 is formed from a tooth coil of the tooth coils 304 of the third circuit C3. The circuit then enters slot S6 (located three slots clockwise from S3) at the stator core first end 30, extends inwardly in the first direction, in and through slot S6, exits S6 and crosses tooth T between S6 and slot S1, enters slot S1 at the second end 32 extends outwardly, in the second direction, in and through slot S1, and exits S1. The portion of the circuit C3 in slot S6 and S1 is formed from another tooth coil of the tooth coils 304 of the third circuit C3. Each tooth coil 204 has a first and a second side. The sides are opposite each other. The sides of the tooth coils 304 form the portion of the circuit C3 in the slots. For example the portion of the circuit C3 in slots S3 and S4 are formed from the sides of a tooth coil of the plurality of tooth coils 304. The ends 300 and 301 of the third circuit of the stator winding are connected to the terminals for the current of phase C.

In other words, along the repeating winding pattern, the current of phase C travels axially inwardly in the first direction through a second slot S3. The third slot S3 is located two spaces clockwise of the first slot S1. The phase C current then travels axially outwardly in the second direction through a second slot S4 that is located one place clockwise from the third slot S3, axially inwardly in the first direction through a sixth slot S6 that is located three places clockwise from the third slot S3, and axially outwardly in the axial direction through the first slot S1 that is located four places clockwise from the third slot S3.

The current of phase C, at the start travels, through a tooth coil 304 in slots S3 and S4, then through a tooth coil 304 in slots S6 and S1. The tooth coils 304 of the third circuit C3 are joined in series.

Accordingly, the slots distribution on phases A, B and C of the stator winding is summarized in the following chart.

| | Inward (X) | Outward (•) |
|---|---|---|
| Phase A | S1 | S2 |
| | S4 | S5 |
| Phase B | S2 | S3 |
| | S5 | S6 |
| Phase C | S3 | S4 |
| | S6 | S1 |

As set forth above, due to the use of rotor 12 having the outer copper layer 22, the tooth-coil windings 36 can be employed in the embodiment illustrated in FIGS. 4 and 5 as well. The winding configurations of the embodiment shown in FIGS. 4 and 5 have the same advantages as those of the embodiment shown in FIGS. 1-3 described above.

Again, one of the defining characteristics of the stator assembly 38 of the embodiment depicted in FIGS. 4 and 5 is that its winding configuration has a number of slots (S), number of poles (2p) and number of phases (m), such that the number of slots per pole per phase (q) is sub-unitary, as represented by the following:
S=6 slots
p=2 pairs
m=3 phases
q=S/2p/m=6/4/3=0.5 slots/pole/phase

When the motor 10 illustrated in FIGS. 4 and 5 is supplied, from a frequency converter, at 1,000 Hz, the synchronous speed (nₛ) of the motor 10 is 30,000 rpm, as represented by the following:
f=1,000 Hz
p=2 pairs
nₛ=120*f/2p=120*1,000/4=30,000 rpm

Other motors 10 having fractional-slot tooth-coil windings are also within the scope of the present invention. Again, the defining characteristics of the stator assemblies 38 of these motors 10 are that the number (q) of slots per pole per phase is less than 1.0 (i.e., q<1.0).

Another important factor driving the designs of other embodiments is the winding factor (k_{wt}), which is proportional with torque (τ). If a motor 10 has a low winding factor, in order to have the desired performance, it may be required to have a higher current or an increased number of turns.

From the foregoing, it will be seen that this invention is one well adapted to attain all the ends and objects hereinabove set forth together with other advantages which are obvious and which are inherent to the structure. It will be understood that certain features and sub combinations in addition to those shown and discussed herein are possible. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A high speed electric induction motor assembly, said motor assembly comprising:
a rotor with a circumferential core and a layer of conductive material over said core, said layer comprising copper;
a stator core defining a plurality of axially-extending slots therein forming a plurality of adjacent pairs of slots, a plurality of teeth, wherein a different one of a tooth from said plurality of teeth separate slots forming each pair of adjacent pairs of slots; said stator core defining a hollow, each of said adjacent pairs of slots opening into said hollow;
a plurality of circuits forming a multiphase fractional-slot tooth-coil winding carried by said stator core;
said plurality of circuits including a plurality of tooth coils, each tooth coil has a first and second side;
wherein in each slot of said plurality of slots are at least two tooth coil sides, each of the two tooth coil sides in each slot is from a different tooth coil of said plurality of tooth coils, each of these different two tooth coil sides carries a current which is at a different phase.

2. The motor assembly of claim 1, wherein said stator core has an inner surface defining said hollow.

3. The motor assembly of claim 2, further comprising a mechanical radial air gap defined between said inner surface of said stator core and an outer surface of said layer of conductive material, wherein said motor assembly has a magnetic effective radial air gap that is larger than said mechanical radial air gap.

4. The motor assembly of claim 3, wherein said magnetic effective radial gap extends a radial distance through at least a portion of the radial thickness of said layer of said conductive material.

5. The motor assembly of claim 1, wherein the ratio of said slots per poles per phases is a non-integer less than 1.

6. The motor assembly of claim 5, wherein said motor assembly has 18 slots and 12 poles 3 phases.

7. The motor assembly of claim 5, wherein said motor assembly has 6 slots and 4 poles, and 3 phases.

8. The motor assembly of claim 1, wherein said plurality of tooth coils includes:
a first plurality of tooth coils, said first plurality of tooth coils of a first circuit of said plurality of circuits, said first circuit carries a current at a first phase,
a second plurality of tooth coils, said second plurality of a second circuit of said plurality of circuits, said second circuit carries current at a second phase;
a third plurality of tooth coils, said third plurality of a second circuit of said plurality of circuits, said second circuit carries current at a second phase.

9. The motor assembly of claim 8, wherein said first circuit extends axially in a first direction relative to an axis of said rotor in a first slot of said plurality of said slots, said circuit in said first slot is a side of one of said first plurality of tooth coils and also one of said two tooth coil sides in each slot from a different one of the tooth coils of said plurality of tooth coils.

10. The motor assembly of claim 9, wherein said first circuit extends axially in a second direction relative to an axis of said rotor in a second slot of said plurality of said slots, said first slot and second slot forming a pair of adjacent slots of said plurality of adjacent slots, said circuit in said second slot is another side of said tooth coil in said first slot and also one of said two tooth coil sides in each slot from a different one of the tooth coils of said plurality of tooth coils.

11. The motor assembly of claim 9, wherein said second circuit extends axially in the first direction relative to an axis of said rotor in the second slot of said plurality of said slots, said second circuit in said second slot is a side of one of said second plurality of tooth coils and also another one of said two tooth coil sides in each slot from a different one of the tooth coils of said plurality of tooth coils.

12. The motor assembly of claim 9, wherein said third circuit extends axially in the second direction relative to an axis of said rotor in the first slot of said plurality of said slots, said third circuit in said first slot is a side of one of said third plurality of tooth coils and also another one of said two tooth coil sides in each slot from a different one of the tooth coils of said plurality of tooth coils.
